(19) United States
(12) Patent Application Publication
(10) Pub. No.: US 2012/0092387 A1
(43) Pub. Date: Apr. 19, 2012

(54) OVERDRIVING APPARATUS AND OVERDRIVING VALUE GENERATING METHOD

(75) Inventors: Fu-Chi Yang, Miao-Li County (TW); Ming-Chia Shih, Miao-Li County (TW)

(73) Assignee: CHIMEI INNOLUX CORPORATION STSP BRANCH, Miao-Li County (TW)

(21) Appl. No.: 13/218,992

(22) Filed: Aug. 26, 2011

(30) Foreign Application Priority Data
Oct. 19, 2010 (TW) 99135603

(51) Int. Cl. G09G 5/10; G09G 3/36

(52) U.S. Cl. 345/690; 345/88

(57) ABSTRACT

An overdriving apparatus including a frame state calculating unit, a white tracking unit, and an overdriving value generator is provided. The frame state calculating unit generates a frame state index according to a previous frame data and a current frame data. The white tracking unit coupled to the frame state calculating unit has pretilt white tracking tables. When the frame state index indicates that a current frame is a dynamic frame, the white tracking unit selects at least one of the pretilt white tracking tables according to the frame state index and finds color grayscales corresponding to the current frame data according to the selected pretilt white tracking table. The overdriving value generator coupled to the white tracking unit generates overdriving values corresponding to the current frame data according to the color grayscales and previous color grayscales.

### CROSS-REFERENCE TO RELATED APPLICATION

This application claims the priority benefit of Taiwan application serial no. 99135603, filed Oct. 19, 2010. The entirety of the above-mentioned patent application is hereby incorporated by reference herein and made a part of this specification.

### BACKGROUND OF THE INVENTION

1. Field of the Invention

The invention generally relates to an overdriving apparatus and an overdriving value generating method, and more particularly, to an overdriving apparatus and an overdriving value generating method which can improve the response speed of liquid crystal.

2. Description of Related Art

In recent years, portable electronic products and flat panel display products have become widespread along with the rapid advancement of the semiconductor technology. Among all different types of flat panel displays, liquid crystal display (LCD) has become the mainstream product in the display market thanks to its many advantages, such as low operation voltage, no radiation, light weight, and small volume.

Generally speaking, blur residual images may be easily produced in a LCD because the liquid crystal molecules thereof have very slow response speed. Accordingly, an overdriving technique is conventionally adopted for resolving this problem. Existing overdriving techniques can be roughly categorized into single-level overdriving techniques and two-level overdriving techniques. However, regardless of which type of overdriving technique is adopted, the rhino-horn effect will be produced in some grayscale conversion processes (particularly, when the panel is applied to a low temperature environment and low grayscales are converted to high grayscales), as the circled spot A in FIG. 1A.

The “rhino-horn effect” refers to that when an input grayscale is converted (for example, a grayscale 0 is converted to a grayscale 204), if herein an overdriving value 255 is applied to the pixels through table lookup, a tilt angle error is likely to be produced in the liquid crystal molecules of the pixels due to the overlarge driving voltage they receive. Subsequently, if the input grayscale remains at the grayscale 204, the pixels will slowly resume the brightness of a target grayscale after they reach the brightness of a lower grayscale (i.e., the tilt angle of the liquid crystal molecules gradually returns to a correct angle). Thus, before applying a high overdriving value, a low grayscale should be sent to the pixels to pretilt the liquid crystal molecules in the pixels, so that the tilt angle error of the liquid crystal molecules in the pixels is prevented.

FIG. 1B is a system diagram of a conventional overdriving apparatus. The overdriving apparatus 100 includes frame buffers 110 and 120 and an overdriving value generator 130. The overdriving value generator 130 receives frame data Fn, Fn−1, and Fn−2 and generates an overdriving value OD(n−1) corresponding to the frame data Fn−1. Herein the frame data Fn is a currently received frame data, the frame data Fn−1 is a previously received frame data, the frame data Fn−2 is a frame data received even earlier than the frame data Fn−1, and the frame data Fn−1 is the frame data to be displayed (i.e., a received frame data is displayed after it is delayed for a frame period). Regarding the same pixel, assuming that the corresponding grayscale in the frame data Fn is 128, the corresponding grayscale in the frame data Fn−1 is 0, and the corresponding grayscale in the frame data Fn−2 is 0, because the corresponding grayscale in the frame data Fn and Fn−1 changes from 0 to 128, a pretilting operation should be performed by the pixel to prevent the rhino-horn effect. Thus, the corresponding grayscale in the frame data Fn−1 should be adjusted to 8. However, the hardware cost of the overdriving apparatus 100 is increased since it has two frame buffers.

### SUMMARY OF THE INVENTION

Accordingly, the invention is directed to an overdriving apparatus and an overdriving value generating method, wherein the production of rhino-horn effect is prevented and the problems of motion color blur and overshooting (or undershooting) are resolved.

The invention provides an overdriving apparatus adaptable to a display panel. The overdriving apparatus includes a frame state calculating unit, a white tracking unit, and an overdriving value generator. The frame state calculating unit generates at least one frame state index according to a previous frame data and a current frame data. The white tracking unit is coupled to the frame state calculating unit and has an original white tracking table and a plurality of pretilt white tracking tables. When the frame state index indicates that a current frame is a static frame, the white tracking unit finds a plurality of first color grayscales corresponding to a plurality of first display data of the current frame data according to the original white tracking table. When the frame state index indicates that the current frame is a dynamic frame, the white tracking unit selects at least one of the pretilt white tracking tables according to the frame state index and finds a plurality of second color grayscales corresponding to the first display data according to the selected pretilt white tracking table. The overdriving value generator is coupled to the white tracking unit. The overdriving value generator generates a plurality of overdriving values corresponding to the first display data according to the first color grayscales or the second color grayscales and a plurality of previous color grayscales corresponding to the previous frame data.

According to an embodiment of the invention, the frame state calculating unit includes a motion vector statistic unit and a calculation unit. The motion vector statistic unit receives the previous frame data and the current frame data, calculates a total of a plurality of first differences between a part of the first display data that is smaller than or equal to a threshold grayscale and a corresponding part of a plurality of second display data of the previous frame data and between a part of the second display data that is smaller than or equal to the threshold grayscale and a corresponding part of the first display data, and generates a total error according to a part of the first differences that is greater than an error threshold. The calculation unit is coupled to the motion vector statistic unit and generates the frame state index according to the total error.

According to an embodiment of the invention, the frame state calculating unit further includes a temperature sensing unit coupled to the motion vector statistic unit and the calculation unit. The temperature sensing unit generates a temperature weight according to the temperature of the display panel. The motion vector statistic unit further adjusts the total error according to the temperature weight, and the calculation unit generates the frame state index according to the total error and the temperature weight.

According to an embodiment of the invention, the frame state calculating unit further includes a time counting unit coupled to the motion vector statistic unit and the calculation unit. The time counting unit generates the time weight according to a display time of the display panel. The motion vector statistic unit further adjusts the total error according to the time weight, and the calculation unit generates the frame state index according to the total error and the time weight.

According to an embodiment of the invention, the calculation unit includes a multiplier and an anti-flicker processing unit. The multiplier is coupled to the motion vector statistic unit. The multiplier receives the total error and generates a final frame state value according to the total error. The anti-flicker processing unit is coupled to the multiplier. The anti-flicker processing unit receives the final frame state value and a previous frame state index and generates the frame state index according to the final frame state value and the previous frame state index.

According to an embodiment of the invention, the motion vector statistic unit includes a subtractor, an accumulator, a control unit, and a value processing unit. The subtractor receives the first display data and the second display data and calculates a plurality of second differences between the corresponding parts of the first display data and the second display data. The accumulator is coupled to the subtractor. The accumulator determines whether to accumulate the second differences according to an accumulation control signal and generates an accumulation result. The control unit receives the first display data, the second display data, and the second differences and controls the accumulator to accumulate the second differences through the accumulation control signal when each of the second differences is greater than the error threshold and the corresponding first display data or the corresponding second display data is smaller than or equal to the threshold grayscale. The value processing unit is coupled to the accumulator. The value processing unit receives the accumulation result and generates the total error according to the accumulation result.

According to an embodiment of the invention, the value processing unit includes a compressor, a shifter, and a boundary protection unit. The compressor is coupled to the accumulator. The compressor receives the accumulation result and compresses the bit number of the accumulation result to generate a compression result. The shifter is coupled to the compressor. The shifter receives the compression result and subtracts a shift number from the compression result to generate a shift result. The boundary protection unit is coupled to the shifter. When the shift result is greater than a maximum value, the maximum value is served as the total error, and when the shift result is smaller than or equal to the maximum value, the shift result is served as the total error, wherein the maximum value is equal to a customized threshold or a quotient obtained by dividing a product of a data threshold, a temperature weight, and a time weight by a reference value.

According to an embodiment of the invention, when the frame state index is not directly corresponding to the original white tracking table or the pretilt white tracking tables, two of the original white tracking table and the pretilt white tracking tables that are close to the frame state index are selected according to frame state indexes corresponding to the original white tracking table and the pretilt white tracking tables, and an interpolation calculation is performed by using the frame state indexes corresponding to the selected original white tracking table or pretilt white tracking tables and the frame state index to obtain the second color grayscales.

According to an embodiment of the invention, the display panel has a plurality of display areas, and the frame state calculating unit calculates a plurality of frame state indexes corresponding to the display areas according to the previous frame data and the current frame data.

The invention also provides an overdriving value generating method adaptable to an overdriving apparatus coupled to a display panel. The overdriving value generating method includes following steps. A previous frame data and a current frame data are received. At least one frame state index is generated by performed calculation according to the previous frame data and the current frame data. When the frame state index indicates that a current frame is a static frame, a plurality of first color grayscales corresponding to a plurality of first display data of the current frame data is found according to the original white tracking table. When the frame state index indicates that the current frame is a dynamic frame, at least one of the pretilt white tracking tables is selected according to the frame state index, and a plurality of second color grayscales corresponding to the first display data is found according to the selected pretilt white tracking table. A plurality of overdriving values corresponding to the first display data is generated according to the first color grayscales or the second color grayscales and a plurality of previous color grayscales corresponding to the previous frame data.

According to an embodiment of the invention, the step of generating the frame state index according to the previous frame data and the current frame data includes calculating a total of a plurality of first differences between a part of the first display data that is smaller than or equal to a threshold grayscale and a corresponding part of a plurality of second display data of the previous frame data and between a part of the second display data that is smaller than or equal to the threshold grayscale and a corresponding part of the first display data, generating a total error according to a part of the first differences that is greater than an error threshold, and generating the frame state index according to the total error.

According to an embodiment of the invention, the step of generating the frame state index according to the previous frame data and the current frame data further includes generating a temperature weight according to the temperature of the display panel, adjusting the total error according to the temperature weight, and generating the frame state index according to the total error and the temperature weight.

According to an embodiment of the invention, the step of generating the frame state index according to the previous frame data and the current frame data further includes generating a time weight according to a display time of the display panel, adjusting the total error according to the time weight, and generating the frame state index according to the total error and the time weight.

According to an embodiment of the invention, the step of generating the frame state index according to the total error includes generating a final frame state value according to the total error and generating the frame state index according to the final frame state value and a previous frame state index.

According to an embodiment of the invention, the threshold grayscale is 40.

According to an embodiment of the invention, the step of calculating the total of the first differences between the part of the first display data that is smaller than or equal to the threshold grayscale and the corresponding part of the second display data of the previous frame data and between the part of the second display data that is smaller than or equal to the threshold grayscale and the corresponding part of the first display data and generating the total error according to the part of the first differences that is greater than the error threshold includes calculating a plurality of second differences between the corresponding parts of the first display data and the second display data, accumulating the second differences when each of the second differences is greater than the error threshold and the corresponding first display data or the corresponding second display data is smaller than or equal to the threshold grayscale, and generating the total error according to the accumulation result.

According to an embodiment of the invention, the step of generating the total error according to the accumulation result includes compressing the bit number of the accumulation result to generate a compression result, subtracting a shift number from the compression result to generate a shift result, serving a maximum value as the total error when the shift result is greater than the maximum value, and serving the shift result as the total error when the shift result is smaller than or equal to the maximum value.

According to an embodiment of the invention, the step of finding the second color grayscales corresponding to the first display data according to the selected pretilt white tracking table includes when the frame state index is not directly corresponding to the original white tracking table or the pretilt white tracking tables, selecting two of the original white tracking table and the pretilt white tracking tables that are close to the frame state index according to frame state indexes corresponding to the original white tracking table and the pretilt white tracking tables, and performing an interpolation calculation by using the frame state indexes corresponding to the selected original white tracking table or pretilt white tracking tables and the frame state index to obtain the second color grayscales.

According to an embodiment of the invention, the display panel has a plurality of display areas, and the step of generating the frame state index according to the previous frame data and the current frame data includes calculating a plurality of frame state indexes corresponding to the display areas according to the previous frame data and the current frame data.

As described above, the invention provides an overdriving apparatus and an overdriving value generating method. When a current frame is a dynamic frame, at least one of a plurality of pretilt white tracking tables is selected according to a frame state index. The color grayscale corresponding to each first display data of the current frame data is calculated according to the selected pretilt white tracking table. Overdriving values corresponding to the first display data are generated according to the color grayscales. Thereby, when the current frame is a dynamic frame, a pretilt effect of the liquid crystal can be achieved in the pixels through the pretilt white tracking tables so that the possibility of tile angle error in the liquid crystal is reduced to prohibit the rhino-horn effect, and the rotating speed of the liquid crystal is increased to resolve the problems of motion color blur and overshooting (or undershooting) in dynamic frames.

These and other exemplary embodiments, features, aspects, and advantages of the invention will be described and become more apparent from the detailed description of exemplary embodiments when read in conjunction with accompanying drawings.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a diagram illustrating the rhino-horn effect of a conventional overdriving technique.

FIG. 1B is a system diagram of a conventional overdriving apparatus.

FIG. 2 is a system diagram of a display 200 according to an embodiment of the invention.

FIG. 3 is a system diagram of an overdriving apparatus 211 in FIG. 2 according to an embodiment of the invention.

FIG. 4 is a diagram illustrating conversion curves of an original white tracking table and a plurality of pretilt white tracking tables according to an embodiment of the invention.

FIG. 5 is a diagram illustrating frame state indexes corresponding to an original white tracking table and a plurality of pretilt white tracking tables according to an embodiment of the invention.

FIG. 6 is a system diagram of a motion vector statistic unit 341 in FIG. 3 according to an embodiment of the invention.

FIG. 7 is a flowchart of an overdriving value generating method according to an embodiment of the invention.

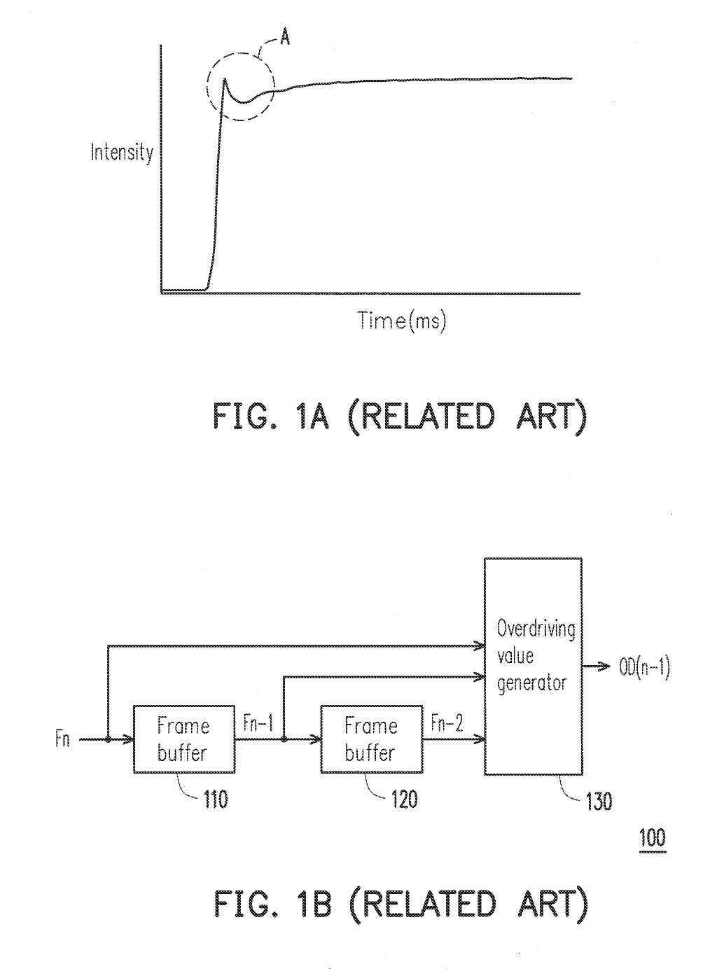

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

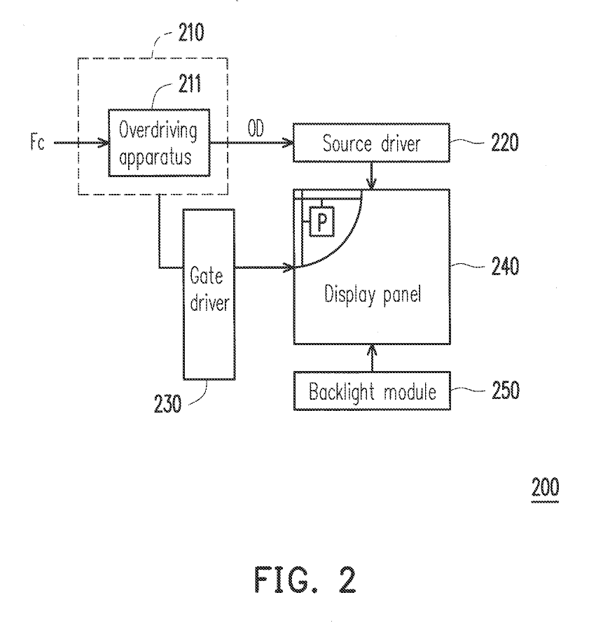

FIG. 2 is a system diagram of a display 200 according to an embodiment of the invention. Referring to FIG. 2, in the present embodiment, the display 200 including a timing controller 210, a source driver 220, a gate driver 230, a display panel 240, and a backlight module 250. The display 200 may be a liquid crystal display (LCD), and correspondingly, the display panel 240 may be a LCD panel. Generally speaking the display panel 240 has a plurality of pixels P arranged into an array, and which is driven by the source driver 220 and the gate driver 240 to display images by using the (surface) light source provided by the backlight module 250.

As shown in FIG. 2, the source driver 220 drives the display panel 240 according to an overdriving value OD provided by the timing controller 210, and an overdriving apparatus 211 is disposed in the timing controller 210 for generating the overdriving value OD. The structure of the overdriving apparatus 211 provided by the invention is different from that of the conventional overdriving apparatus 100. Below, the overdriving apparatus 211 will be described in detail with reference to an embodiment of the invention.

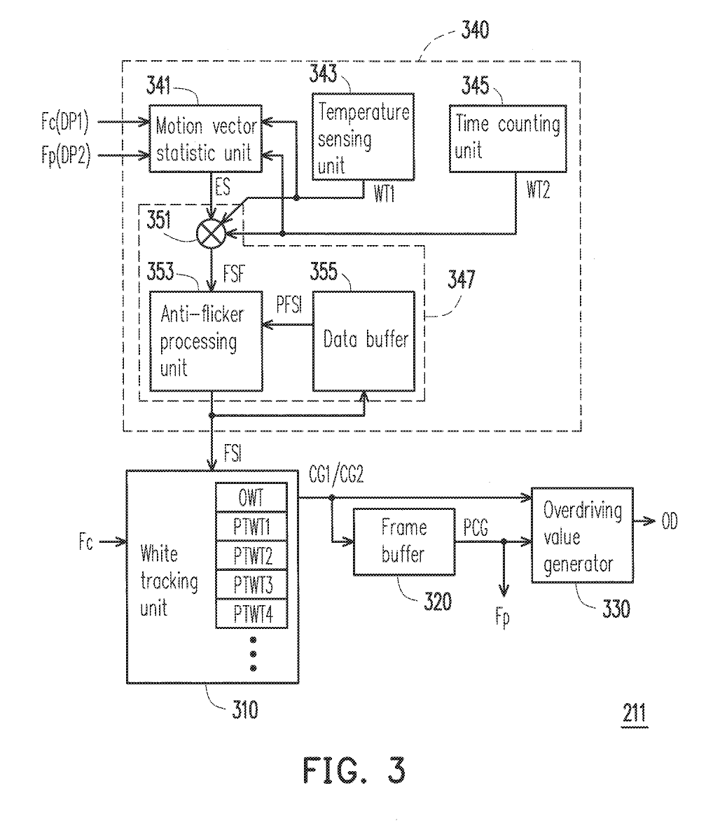

FIG. 3 is a system diagram of the overdriving apparatus 211 in FIG. 2 according to an embodiment of the invention. Referring to FIG. 3, in the present embodiment, the overdriving apparatus 211 includes a white tracking unit 310, a frame buffer 320, an overdriving value generator 330, and a frame state calculating unit 340. The white tracking unit 310 has an original white tracking table OWT and pretilt white tracking tables PTWT1, PTWT2, and etc. The white tracking unit 310 receives a frame state index FSI and a current frame data Fc, wherein the frame state index FSI is generated by the frame state calculating unit 340. The frame state index FSI indicates whether a current frame displayed according to the current frame data Fc is a dynamic frame or a static frame.

When the frame state index FSI indicates that the current frame is a static frame, the white tracking unit 310 finds a plurality of first color grayscales CG1 corresponding to a plurality of first display data DP1 of the current frame data Fc according to the original white tracking table OWT. When the frame state index FSI indicates that the current frame is a dynamic frame, the white tracking unit 310 selects at least one of the pretilt white tracking tables PTWT1, PTWT2, and so on according to the frame state index FSI and finds a plurality of second color grayscales CG2 corresponding to the first display data DP1 according to the selected pretilt white tracking table.

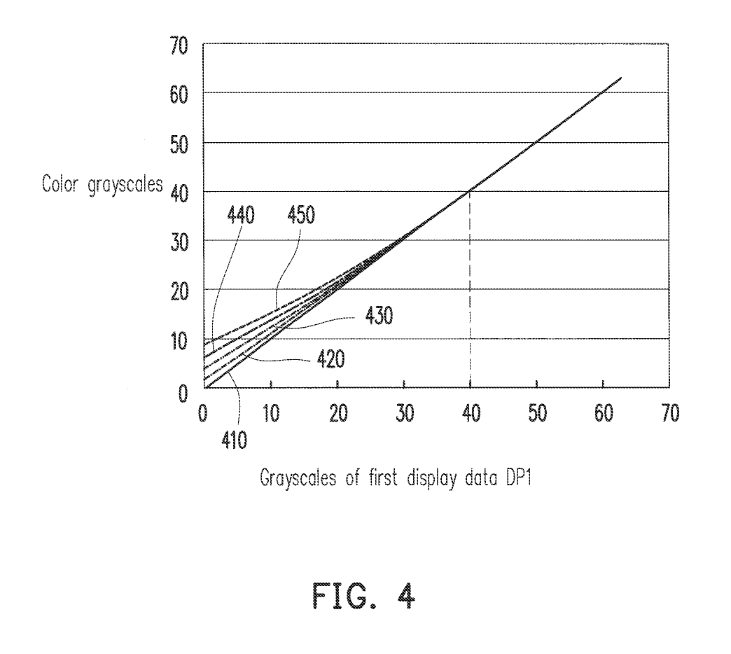

FIG. 4 is a diagram illustrating conversion curves of an original white tracking table and a plurality of pretilt white tracking tables according to an embodiment of the invention. Referring to FIG. 3 and FIG. 4, in the present embodiment, it is assumed that the white tracking unit 310 has the original white tracking table OWT and the pretilt white tracking tables PTWT1-PTWT4. In FIG. 4, the curve 410 is the conversion curve of the original white tracking table OWT, the curve 420 is the conversion curve of the pretilt white tracking table PTWT1, the curve 430 is the conversion curve of the pretilt white tracking table PTWT2, the curve 440 is the conversion curve of the pretilt white tracking table PTWT3, and the curve 450 is the conversion curve of the pretilt white tracking table PTWT4.

As described above, when the current frame is a static frame, the conversion between the grayscales and the color grayscales (i.e., the first color grayscales CG1) of the first display data DP1 of the current frame data Fc is as shown by the curve 410. When the current frame is a dynamic frame, the conversion between the grayscales and the color grayscales (i.e., the second color grayscales CG2) of the first display data DP1 of the current frame data Fc is as shown by the curves 420-450, and when a greater variation is indicated by the frame state index FSI, a pretilt white tracking table of a higher initial value (i.e., the grayscale of the first display data DP1 is 0) is selected. As shown by the curves 420-450, a higher color grayscale is obtained through the conversion when the grayscale of the first display data DP1 is a lower grayscale (for example, when the grayscale is smaller than or equal to 40). Namely, a pretilt effect is produced in the liquid crystal. Thereby, the possibility of tilt angle error in the liquid crystal molecules is reduced so that the rhino-horn effect is prohibited, and the rotating speed of the liquid crystal is increased so that the problems of motion color blur and overshooting (or undershooting) in dynamic frames are resolved.

In addition, the white tracking unit 310 may select one of the pretilt white tracking tables PTWT1-PTWT4 according to the frame state index FSI and generate the second color grayscales CG2 according to the selected pretilt white tracking table. Or, the white tracking unit 310 may also select two of the original white tracking table OWT and the pretilt white tracking tables PTWT1-PTWT4 according to the frame state index FSI and perform an interpolation calculation to generate the second color grayscales CG2 according to the selected white tracking tables.

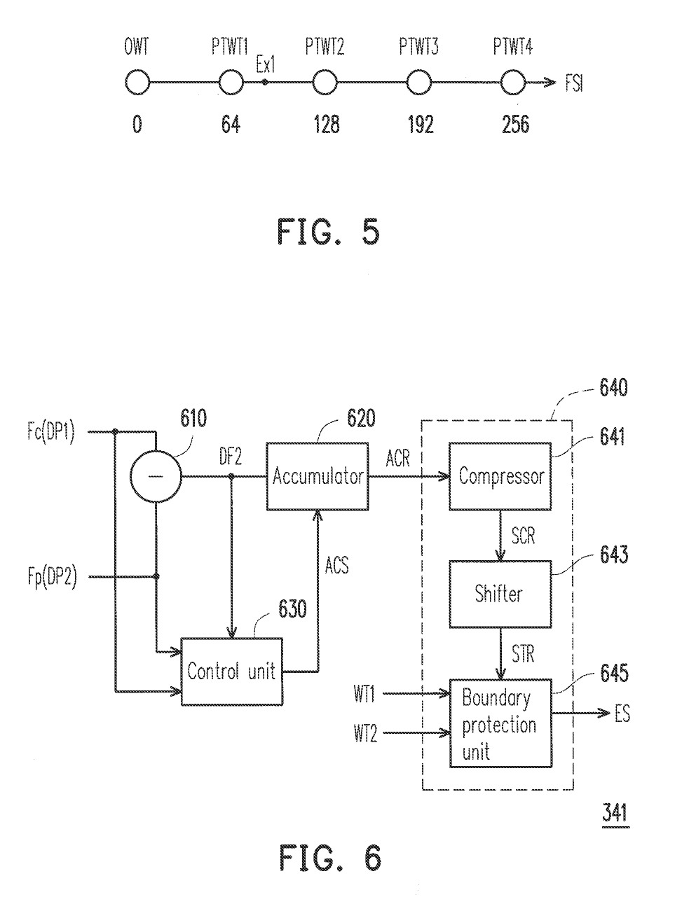

FIG. 5 is a diagram illustrating frame state indexes corresponding to an original white tracking table and a plurality of pretilt white tracking tables according to an embodiment of the invention. Referring to FIG. 5, in the present embodiment, it is assumed that the white tracking unit 310 has the original white tracking table OWT and the pretilt white tracking tables PTWT1-PTWT4. Besides, it is assumed that the frame state index FSI corresponding to the original white tracking table OWT is 0, the frame state index FSI corresponding to the pretilt white tracking table PTWT1 is 64, the frame state index FSI corresponding to the pretilt white tracking table PTWT2 is 128, the frame state index FSI corresponding to the pretilt white tracking table PTWT3 is 192, and the frame state index FSI corresponding to the pretilt white tracking table PTWT4 is 256.

As described above, one technique is to select a closer pretilt white tracking table and generate the second color grayscales CG2 according to the selected pretilt white tracking table (for example, the pretilt white tracking tables PTWT1-PTWT4). Besides, if the frame state index FSI is closer to the frame state index FSI corresponding to the original white tracking table OWT, the original white tracking table OWT may be selected or not selected according to a system preset value. Moreover, if the frame state index FSI is greater than the frame state index FSI corresponding to the pretilt white tracking table PTWT4, the pretilt white tracking table PTWT4 is selected. If the frame state index FSI is 80 (i.e., as indicated by the black dot EX1 in FIG. 5), a closer pretilt white tracking table (i.e., the pretilt white tracking table PTWT1) is selected, and the second color grayscales CG2 are generated according to the selected pretilt white tracking table PTWT1.

Another technique is to select closer two of the original white tracking table OWT and the pretilt white tracking tables PTWP1-PTWT4, and an interpolation calculation is performed on the second color grayscales CG2 obtained from the selected pretilt white tracking tables (for example, the pretilt white tracking tables PTWP1-PTWT4) or original white tracking table OWT according to the frame state indexes FSI corresponding to the selected pretilt white tracking tables (for example, the pretilt white tracking tables PTWP1-PTWT4) or original white tracking table OWT and the frame state index FSI corresponding to the current frame data Fc, so as to obtain the second color grayscales CG2 corresponding to the first display data DP1. Furthermore, if the frame state index FSI is greater than the frame state index FSI corresponding to the pretilt white tracking table PTWT4, the pretilt white tracking table PTWT4 is selected and no interpolation calculation is performed.

For example, if the frame state index FSI is 80 (i.e., indicated by the black dot EX1 in FIG. 5) and the grayscale of the first display data DP1 is assumed to be 0, the corresponding second color grayscales in the pretilt white tracking tables PTWT1 and PTWT2 are respectively 2 and 4, and the second color grayscale CG2 corresponding to the first display data DP1 is

$$2 + \frac{80 - 64}{128 - 64} ( 4 - 2 ) = 2.5 .$$

After being rounded, the second color grayscale CG2 corresponding to the first display data DP1 is 3.

Referring to FIG. 3 again, the frame buffer 320 and the overdriving value generator 330 are respectively coupled to the white tracking unit 310 for respectively receiving the first color grayscales CG1 or the second color grayscales CG2. The frame buffer 320 outputs the first color grayscales CG1 or the second color grayscales CG2 corresponding to the previous frame as a plurality of previous color grayscales PCG corresponding to the previous frame data Fp. In the present embodiment, only the frame buffer 320 is adopted so that the hardware cost is reduced compared to that conventional technique in which two frame buffers are adopted.

The overdriving value generator 330 generates a plurality of overdriving values OD corresponding to the first display data DP1 according to the first color grayscales CG1 or the second color grayscales CG2 corresponding to the current frame data Fc and the previous color grayscales PCG corresponding to the previous frame data Fp. In addition, in some embodiments, the frame buffer 320 is integrated inside the overdriving value generator 330.

The frame state calculating unit 340 generates at least one frame state index FSI according to the previous frame data Fp and the current frame data Fc. To be specific, the frame state calculating unit 340 includes a motion vector statistic unit 341, a temperature sensing unit 343, a time counting unit 345, and a calculation unit 347.

The temperature sensing unit 343 generates a temperature weight WT1 according to the temperature of the display panel 240. The time counting unit 345 generates a time weight WT2 according to a display time of the display panel 240. The motion vector statistic unit 341 is coupled to the temperature sensing unit 343 and the time counting unit 345 and receives the previous frame data Fp and the current frame data Fc.

The motion vector statistic unit 341 calculates a total of a plurality of first differences between a part of the first display data DP1 that is smaller than or equal to a threshold grayscale (for example, a grayscale 40) and a corresponding part of a plurality of second display data DP2 of the previous frame data Fp and between a part of the second display data DP2 that is smaller than or equal to the threshold grayscale and the corresponding part of the first display data DP1 and generates the total error ES according to foregoing total value. Herein the first differences are differences between the grayscales of the first display data DP1 and the grayscales of the second display data DP2 (i.e., the previous color grayscales), and the first differences are greater than the error threshold (for example, 50). Besides, the motion vector statistic unit 341 adjusts the total error ES according to the temperature weight WT1 and the time weight WT2.

The calculation unit 347 is coupled to the motion vector statistic unit 341, the temperature sensing unit 343, and the time counting unit 345 and generates the frame state index FSI according to the total error ES, the temperature weight WT1, and the time weight WT2. In addition, in other embodiments, the calculation unit 347 may generate the frame state index FSI only according to the total error ES or according to the total error ES and one of the temperature weight WT1 and the time weight WT2. However, the invention is not limited thereto, and how the calculation unit 347 generates the frame state index FSI may be determined by those having ordinary knowledge in the art.

The calculation unit 347 includes a multiplier 351, an anti-flicker processing unit 353, and a data buffer 355. The multiplier 351 is coupled to the motion vector statistic unit 341, the temperature sensing unit 343, and the time counting unit 345. The multiplier 351 receives the total error ES, the temperature weight WT1, and the time weight WT2 and generates a final frame state value FSF according to the total error ES, the temperature weight WT1, and the time weight WT2. The anti-flicker processing unit 353 is coupled to the multiplier 351. The anti-flicker processing unit 353 receives the final frame state value FSF and a previous frame state index PFSI and generates the frame state index FSI according to the final frame state value FSF and the previous frame state index PFSI (i.e., the average value of the frame state index FSI corresponding to at least a previous frame). The data buffer 355 is coupled to the anti-flicker processing unit 353 to receive the frame state index FSI and provide the previous frame state index PFSI.

When the error between the final frame state value FSF and the previous frame state index PFSI is very large, the anti-flicker processing unit 353 adds an appropriate value to the previous frame state index PFSI and serves the result as the frame state index FSI, wherein the appropriate value may be ⅛ of the error between the final frame state value FSF and the previous frame state index PFSI. When the error between the final frame state value FSF and the previous frame state index PFSI is within an acceptable range, the anti-flicker processing unit 353 serves the final frame state value FSF as the frame state index FSI. Thereby, flicker in the frame caused by large error between the final frame state value FSF and the previous frame state index PFSI can be prevented. In addition, the number of previous frames adopted for generating the previous frame state index PFSI is not limited in the invention, and which can be adjusted according to the circuit design or the user requirement.

FIG. 6 is a system diagram of the motion vector statistic unit 341 in FIG. 3 according to an embodiment of the invention. Referring to FIG. 6, in the present embodiment, the motion vector statistic unit 341 includes a subtractor 610, an accumulator 620, a control unit 630, and a value processing unit 640. The subtractor 610 receives the first display data DP1 and the second display data DP2 and calculates a plurality of second differences DF2 between the corresponding parts of the first display data DP1 and the second display data DP2, wherein the second differences DF2 are absolute values.

The accumulator 620 is coupled to the subtractor 610. The accumulator 620 determines whether to accumulate the second differences DF2 according to an accumulation control signal ACS and generates an accumulation result ACR. The control unit 630 receives the first display data DP1, the second display data DP2, and the second differences DF2. When each second difference DF2 is greater than an error threshold (for example, 50) and the corresponding first display data DP1 or the corresponding second display data DP2 is smaller than or equal to a threshold grayscale (for example, a grayscale 40), the control unit 630 controls the accumulator 620 to accumulate the second differences DF2 through the accumulation control signal ACS. The value processing unit 640 is coupled to the accumulator 620. The value processing unit 640 receives the accumulation result ACR and generates the total error ES according to the accumulation result ACR.

To be specific, the value processing unit 640 includes a compressor 641, a shifter 643, and a boundary protection unit 645. The compressor 641 is coupled to the accumulator 620. The compressor 641 receives the accumulation result ACR and compresses the bit number of the accumulation result ACR to generate a compression result SCR. In other words, if the accumulation result ACR has 28 bits, the compressor 641 can compress the bit number of the accumulation result ACR by dividing the accumulation result ACR by powers of 2 (equivalent to performing right shift operations on the accumulation result ACR). Besides, the sensitivity of the frame state index FSI is reduced by the compression, and the sensitivity of the frame state index FSI is in direct ratio to the compressed compression result SCR. Namely, the greater the bit number of the compression result SCR is, the higher sensitivity the frame state index FSI has, and the smaller the bit number of the compression result SCR is, the lower sensitivity the frame state index FSI has. The sensitivity of the frame state index FSI (i.e. the bit number of the compression result SCR) can be determined by those having ordinary knowledge in the art.

The shifter 643 is coupled to the compressor 641. The shifter 643 receives the compression result and subtracts a shift number from the compression result to generate a shift result STR, wherein the shift number is subtracted to prevent noise interference and ensure the accuracy of the frame state index FSI. The boundary protection unit 645 is coupled to the shifter 643 to receive the shift result STR. When the shift result STR is greater than a maximum value, the maximum value is served as the total error ES, and when the shift result STR is smaller than or equal to the maximum value, the shift result is served as the total error ES, wherein the maximum value may equal to a self-defined threshold or a quotient obtained by dividing the product of a data threshold, the temperature weight WT1, and the time weight WT2 by a reference value, wherein the data threshold and the reference value are not limited in the invention and may vary with different circuit designs.

In the embodiment described above, the frame state calculating unit 340 calculates the frame state index FSI of a displayed frame with the entire display panel. In addition, if the display panel is divided into a plurality of display areas, the frame state calculating unit 340 calculates the frame state index FSI corresponding to each display area according to the previous frame data Fp and the current frame data Fc. Then, the white tracking table (for example, at least one of the original white tracking table OWT and the pretilt white tracking tables PTWT1, PTWT2, and so on) corresponding to each display area is selected according to the frame state index FSI of the display area, and the overdriving value OD corresponding to each first display data is generated according to the selected white tracking table.

In order to prevent adjacent display areas from having very different display effects, adjacent white tracking tables are usually selected corresponding to adjacent display areas. Namely, the white tracking table corresponding to each display area is selected according to the frame state indexes FSI of adjacent display areas.

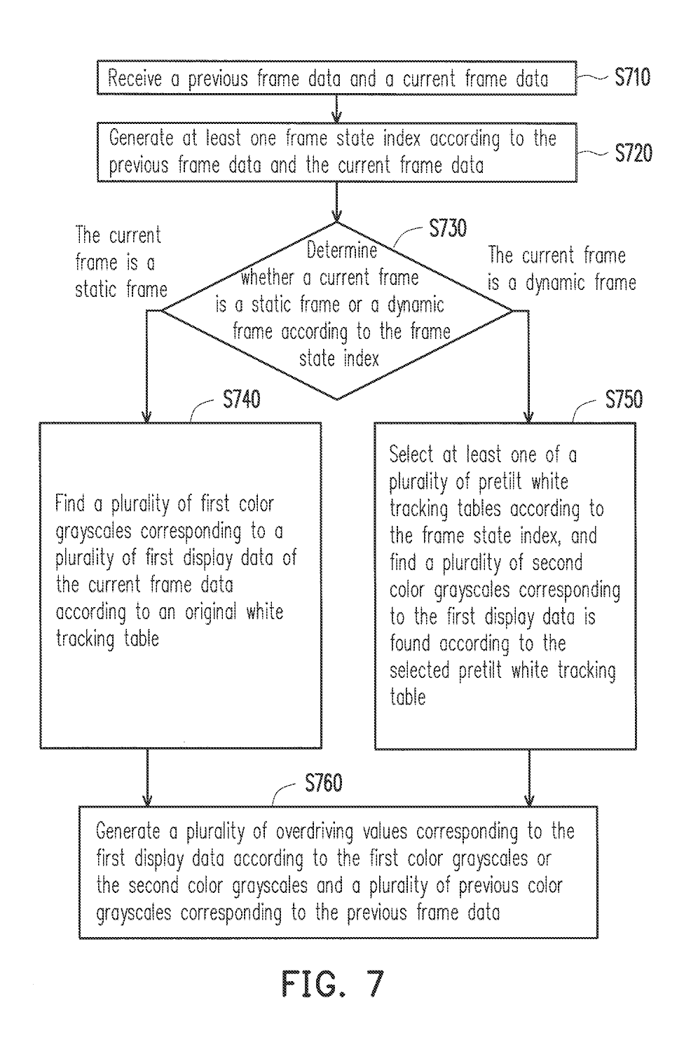

An overdriving value generating method adaptable to the overdriving apparatus 211 can be derived from the embodiments described above. FIG. 7 is a flowchart of an overdriving value generating method according to an embodiment of the invention. Referring to FIG. 7, first, a previous frame data and a current frame data are received (step S710). Then, at least one frame state index is generated according to the previous frame data and the current frame data (step S720). Besides, whether a current frame is a static frame or a dynamic frame is determined according to the frame state index (step S730). If the frame state index indicates that the current frame is a static frame, a plurality of first color grayscales corresponding to a plurality of first display data of the current frame data is found according to the original white tracking table (step S740).

If the frame state index indicates that the current frame is a dynamic frame, at least one of the pretilt white tracking tables is selected according to the frame state index, and a plurality of second color grayscales corresponding to the first display data is found according to the selected pretilt white tracking table (step S750). Finally, a plurality of overdriving values corresponding to the first display data is generated according to the first color grayscales or the second color grayscales and a plurality of previous color grayscales corresponding to the previous frame data (step S760). The details of foregoing steps can be referred to descriptions related to foregoing embodiments and will not be described herein.

In summary, the invention provides an overdriving apparatus and an overdriving value generating method. When a current frame is a dynamic frame, at least one of a plurality of pretilt white tracking tables is selected and whether the original white tracking table is selected is determined according to a frame state index. The color grayscale corresponding to each first display data of the current frame data is calculated according to the selected original white tracking table and pretilt white tracking tables. After that, overdriving values corresponding to the first display data are generated according to the color grayscales. Thereby, when the current frame is a dynamic frame, liquid crystal molecules in the pixels are pretilted through the pretilt white tracking tables so that the possibility of tilt angle error of the liquid crystal is reduced to prevent the rhino-horn effect, and the rotating speed of the liquid crystal is increased to resolve the problems of motion color blur and overshooting (or undershooting) in the dynamic frame. Moreover, only one frame buffer may be used in an embodiment of the invention to reduce the hardware cost.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. An overdriving apparatus, adaptable to a display panel, the overdriving apparatus comprising:
a frame state calculating unit, generating at least one frame state index according to a previous frame data and a current frame data;
a white tracking unit, coupled to the frame state calculating unit, having an original white tracking table and a plurality of pretilt white tracking tables, wherein when the frame state index indicates that a current frame is a static frame, the white tracking unit finds a plurality of first color grayscales corresponding to a plurality of first display data of the current frame data according to the original white tracking table, and when the frame state index indicates that the current frame is a dynamic frame, the white tracking unit selects at least one of the pretilt white tracking tables according to the frame state index and finds a plurality of second color grayscales corresponding to the first display data according to the selected pretilt white tracking table; and
an overdriving value generator, coupled to the white tracking unit, for generating a plurality of overdriving values corresponding to the first display data according to the first color grayscales or the second color grayscales and a plurality of previous color grayscales corresponding to the previous frame data.

2. The overdriving apparatus according to claim 1, wherein the frame state calculating unit comprises:
a motion vector statistic unit, for receiving the previous frame data and the current frame data, calculating a total of a plurality of first differences between a part of the first display data that is smaller than or equal to a threshold grayscale and a corresponding part of a plurality of second display data of the previous frame data and between a part of the second display data that is smaller than or equal to the threshold grayscale and a corresponding part of the first display data, and generating a total error according to a part of the first differences that is greater than an error threshold;
a calculation unit, coupled to the motion vector statistic unit, for generating the frame state index according to the total error.

3. The overdriving apparatus according to claim 2, wherein the frame state calculating unit further comprises:
a temperature sensing unit, coupled to the motion vector statistic unit and the calculation unit, for generating a temperature weight according to a temperature of the display panel,
wherein the motion vector statistic unit further adjusts the total error according to the temperature weight, and the calculation unit generates the frame state index according to the total error and the temperature weight.

4. The overdriving apparatus according to claim 2, wherein the frame state calculating unit further comprises:
a time counting unit, coupled to the motion vector statistic unit and the calculation unit, for generating a time weight according to a display time of the display panel,
wherein the motion vector statistic unit further adjusts the total error according to the time weight, and the calculation unit generates the frame state index according to the total error and the time weight.

5. The overdriving apparatus according to claim 2, wherein the calculation unit comprises:
a multiplier, coupled to the motion vector statistic unit, for receiving the total error and generating a final frame state value according to the total error; and
an anti-flicker processing unit, coupled to the multiplier, for receiving the final frame state value and a previous frame state index and generating the frame state index according to the final frame state value and the previous frame state index.

6. The overdriving apparatus according to claim 2, wherein the threshold grayscale is 40.

7. The overdriving apparatus according to claim 2, wherein the motion vector statistic unit comprises:
a subtractor, for receiving the first display data and the second display data and calculating a plurality of second differences between the corresponding parts of the first display data and the second display data;
an accumulator, coupled to the subtractor, for determining whether to accumulate the second differences according to an accumulation control signal and generating an accumulation result;
a control unit, for receiving the first display data, the second display data, and the second differences and controlling the accumulator to accumulate the second differences through the accumulation control signal when each of the second differences is greater than the error threshold and the corresponding first display data or the corresponding second display data is smaller than or equal to the threshold grayscale; and
a value processing unit, coupled to the accumulator, for receiving the accumulation result and generating the total error according to the accumulation result.

8. The overdriving apparatus according to claim 7, wherein the value processing unit comprises:
a compressor, coupled to the accumulator, for receiving the accumulation result and compressing a bit number of the accumulation result to generate a compression result;
a shifter, coupled to the compressor, for receiving the compression result and subtracting a shift number from the compression result to generate a shift result;
a boundary protection unit, coupled to the shifter, wherein when the shift result is greater than a maximum value, the boundary protection unit serves the maximum value as the total error, and when the shift result is smaller than or equal to the maximum value, the boundary protection unit serves the shift result as the total error, wherein the maximum value is equal to a customized threshold or a quotient obtained by dividing a product of a data threshold, a temperature weight, and a time weight by a reference value.

9. The overdriving apparatus according to claim 1, wherein when the frame state index is not directly corresponding to the original white tracking table or the pretilt white tracking tables, two of the original white tracking table and the pretilt white tracking tables that are close to the frame state index are selected according to frame state indexes corresponding to the original white tracking table and the pretilt white tracking tables, and an interpolation calculation is performed by using the frame state indexes corresponding to the selected original white tracking table or pretilt white tracking tables and the frame state index to obtain the second color grayscales.

10. The overdriving apparatus according to claim 1, wherein the display panel has a plurality of display areas, and the frame state calculating unit calculates a plurality of frame state indexes corresponding to the display areas according to the previous frame data and the current frame data.

11. An overdriving value generating method, adaptable to an overdriving apparatus coupled to a display panel, the overdriving value generating method comprising:
receiving a previous frame data and a current frame data;
generating at least one frame state index according to the previous frame data and the current frame data;
when the frame state index indicates that a current frame is a static frame, finding a plurality of first color grayscales corresponding to a plurality of first display data of the current frame data according to an original white tracking table;
when the frame state index indicates that the current frame is a dynamic frame, selecting at least one of the pretilt white tracking tables according to the frame state index, and finding a plurality of second color grayscales corresponding to the first display data according to the selected pretilt white tracking table; and
generating a plurality of overdriving values corresponding to the first display data according to the first color grayscales or the second color grayscales and a plurality of previous color grayscales corresponding to the previous frame data.

12. The overdriving value generating method according to claim 11, wherein the step of generating the frame state index according to the previous frame data and the current frame data comprises:
calculating a total of a plurality of first differences between a part of the first display data that is smaller than or equal to a threshold grayscale and a corresponding part of a plurality of second display data of the previous frame data and between a part of the second display data that is smaller than or equal to the threshold grayscale and a corresponding part of the first display data, and generating a total error according to a part of the first differences that is greater than an error threshold; and
generating the frame state index according to the total error.

13. The overdriving value generating method according to claim 12, wherein the step of generating the frame state index according to the previous frame data and the current frame data further comprises:
generating a temperature weight according to a temperature of the display panel;
adjusting the total error according to the temperature weight; and
generating the frame state index according to the total error and the temperature weight.

14. The overdriving value generating method according to claim 12, wherein the step of generating the frame state index according to the previous frame data and the current frame data further comprises:
generating a time weight according to a display time of the display panel;
adjusting the total error according to the time weight; and
generating the frame state index according to the total error and the time weight.

15. The overdriving value generating method according to claim 12, wherein the step of generating the frame state index according to the total error comprises:
generating a final frame state value according to the total error; and
generating the frame state index according to the final frame state value and a previous frame state index.

16. The overdriving value generating method according to claim 12, wherein the threshold grayscale is 40.

17. The overdriving value generating method according to claim 12, wherein the step of calculating the total of the first differences between the part of the first display data that is smaller than or equal to the threshold grayscale and the corresponding part of the second display data of the previous frame data and between the part of the second display data that is smaller than or equal to the threshold grayscale and the corresponding part of the first display data and generating the total error according to the part of the first differences that is greater than the error threshold comprises:
calculating a plurality of second differences between the corresponding parts of the first display data and the second display data;
when each of the second differences is greater than the error threshold and the corresponding first display data or the corresponding second display data is smaller than or equal to the threshold grayscale, accumulating the second differences; and
generating the total error according to the accumulation result.

18. The overdriving value generating method according to claim 17, wherein the step of generating the total error according to the accumulation result comprises:
compressing a bit number of the accumulation result to generate a compression result;
subtracting a shift number from the compression result to generate a shift result;
when the shift result is greater than a maximum value, serving the maximum value as the total error; and
when the shift result is smaller than or equal to the maximum value, serving the shift result as the total error.

19. The overdriving value generating method according to claim 11, wherein the step of finding the second color grayscales corresponding to the first display data according to the selected pretilt white tracking table comprises:
when the frame state index is not directly corresponding to the original white tracking table or the pretilt white tracking tables, selecting two of the original white tracking table and the pretilt white tracking tables that are close to the frame state index according to frame state indexes corresponding to the original white tracking table and the pretilt white tracking tables, and performing an interpolation calculation by using the frame state indexes corresponding to the selected original white tracking table or pretilt white tracking tables and the frame state index to obtain the second color grayscales.

20. The overdriving value generating method according to claim 11, wherein the display panel has a plurality of display areas, and the step of generating the frame state index according to the previous frame data and the current frame data comprises:
calculating a plurality of frame state indexes corresponding to the display areas according to the previous frame data and the current frame data.
